(19) United States
(12) Patent Application Publication
(10) Pub. No.: US 2008/0081199 A1
(43) Pub. Date: Apr. 3, 2008

(54) Ceramic substrate and fabricating method thereof

(75) Inventors: Chih-Hung Wei, Taoyuan Hsien (TW); Yu-Ping Hsieh, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/889,132

(22) Filed: Aug. 9, 2007

(30) Foreign Application Priority Data
Sep. 29, 2006 (TW) 095136188

(51) Int. Cl. B32B 18/00

(52) U.S. Cl. 428/450; 156/327; 156/64; 156/89.11

(57) ABSTRACT

A fabricating method for a ceramic substrate includes the steps of: providing a ceramic thin plate and a pre-mold plate; stacking the ceramic thin plate and the pre-mold plate together; and sintering the ceramic thin plate and the pre-mold plate, both of which jointly form the ceramic substrate. Also, a ceramic substrate composed of a ceramic thin plate and a pre-mold plate is disclosed. The ceramic substrate is an LTCC substrate, and the pre-mold plate is formed by mixing a ceramic material and an inorganic adhesive including crystallized or non-crystallized glass or a glass ceramic, or the inorganic adhesive has properties of a worse chemical activity than other materials, a sintering temperature lower than that of the ceramic material, and being in a liquid phase during a sintering process.

### CROSS REFERENCE TO RELATED APPLICATIONS

This Non-provisional application claims priority under 35 U.S.C. §119(a) on Patent Application No(s). 095136188, filed in Taiwan, Republic of China on Sep. 29, 2006, the entire contents of which are hereby incorporated by reference.

### BACKGROUND OF THE INVENTION

1. Field of Invention

The invention relates to a fabricating method for a ceramic substrate and, in particular to a fabricating method for a ceramic substrate without sintering contraction.

2. Related Art

Recently, the high element density has become a trend of developing electronic products while portable information electronic products and mobile communication products are developed toward the trends of miniaturization, multi-function, high reliability and low price. Thus, active devices and passive devices used in a circuit have been developed toward the trends of integration, system-on-chip and modularization so that the size of the circuit can be effectively reduced, the cost can be reduced, and the competition ability of the product can be enhanced.

The development of the low temperature co-fired ceramics (LTCC) technology increases the volume availability of the electronic product by integrating the circuits of the electronic elements, including the passive devices and the active devices, in a multi-layer structure. As shown in FIG. 1, a conventional LTCC substrate 1 applied to the high-frequency wireless communication element has a multi-layer structure formed by stacking up a plurality of ceramic thin plates 11. A conductive layer 111 and an electrical element 112, such as a resistor, a capacitor or an inductor, are disposed on each layer or between two adjacent layers. The conductive layer 111 may be connected to another conductive layer 111 and another electrical element 112 via the through hole(s) 113. The conductive layer 111 or the electrical element 112 is formed on a surface of the ceramic thin plate 11 by the thick-film printing technology followed by the multi-layer press-forming and the process of sintering at a temperature lower than 1000° C.

However, the ceramic thin plate 11 may have the problem of deformation, such as contraction, distortion, and curved condition because the contraction amounts between the ceramic thin plates 11 in different layers may be different from each other or one another, or voids are generated due to the volatilized solvent or adhesive during the sintering process. This phenomenon becomes obvious when a thinner ceramic thin plate is being manufactured. In addition, the contraction of the ceramic substrate caused during the sintering process may deform the traces or the overall substrate. In addition, the contraction ratios of the ceramic substrates produced in different batches may also be different from one another, thereby increasing the difficulties in the circuit design and the product manufacturing process. Also, the manufacturing cost is increased, the application range is restricted, and the yield and the reliability of the LTCC substrate 1 are influenced.

To solve the above-mentioned problem, several methods of preventing the contraction have been disclosed. In the first method, the contraction direction of the ceramic thin plate 11 is restricted by a mechanical force during the press-forming and the curved condition of the ceramic thin plate 11 is suppressed. However, this method is not suitable for the mass production. In the second method, a pre-mold plate is adhered to a metal plate and then both of the pre-mold plate and the metal plate are proceeded by the sintering process. The metal plate is made of the metal having the high mechanical intensity, such as molybdenum or tungsten, so as to provide a constraining force onto the pre-mold plate of the metal sheet, whereby reducing the phenomenon of the x-y direction contraction of the pre-mold plate. However, the difference between the thermal expansion coefficients of the metal sheet and the pre-mold plate still causes the sintered LTCC substrate to be cambered and curved, even to be cracked. In the third method, an aluminum oxide layer is separately added to the top and bottom surfaces of each pre-mold plate so that a friction force can be provided to restrict the contraction of the pre-mold plate during the sintering process. However, the ceramic substrate is obtained after removing the aluminum oxide layers, which causes the problem that the aluminum oxide layer is remained on the substrate. Also, the manufacturing flow of this method is more complicated and is not suitable for the mass production.

### SUMMARY OF THE INVENTION

In view of the foregoing, the present invention is to provide a fabricating method for fabricating a ceramic substrate, in which the contraction of the ceramic substrate can be effectively suppressed, so that the ceramic substrate is flat and has no curved portion and sintering contraction, and the related art drawbacks can be eliminated. Also, the processes of the fabricating method are simple and are suitable for the mass production.

To achieve the above, the present invention discloses a fabricating method for a ceramic substrate. The method includes the steps of providing a ceramic thin plate and a pre-mold plate, stacking up the ceramic thin plate and the pre-mold plate together, and sintering the ceramic thin plate and the pre-mold plate to jointly form the ceramic substrate.

The invention also discloses a fabricating method for a ceramic substrate. The method includes the steps of providing at least one first ceramic thin plate, at least one second ceramic thin plate and at least one pre-mold plate, stacking up the first ceramic thin plate, the second ceramic thin plate and the pre-mold plate. The pre-mold plate is disposed between the first ceramic thin plate and the second ceramic thin plate, and the first ceramic thin plate, the pre-mold plate and the second ceramic thin plate are performed by a sintering process so as to jointly form the ceramic substrate.

Further, the present invention discloses a ceramic substrate composed of a ceramic thin plate and a pre-mold plate. The ceramic substrate is an LTCC substrate, and the pre-mold plate is formed by mixing a ceramic material and an inorganic adhesive including a glass ceramic or the crystallized or non-crystallized glass. Alternatively, the inorganic adhesive has properties of a worse chemical activity than other materials, a sintering temperature lower than that of the ceramic material, and being in a liquid phase during a sintering process.

As mentioned above, the fabricating method for the ceramic substrate according to the present invention is to dispose a ceramic thin plate on a pre-mold plate so that the ceramic thin plate can provide a constraining force against the pre-mold plate and suppress the contraction of the pre-mold plate during the sintering process. The number of the ceramic thin plates may be greater than one, and those ceramic thin plates may be made of the same material or different materials. Compared with the prior art, the ceramic thin plate and the pre-mold plate have substantially the same property, so the present invention can suppress the contraction during the sintering process and also can prevent the ceramic substrate from being curved so that the flat ceramic substrate can be obtained. Also, the ceramic thin plate for providing a constraining force behaves as one part of the ceramic substrate, so that the removing step can be omitted and the worry of the remained impurity can be avoided. As the result, the yield and the reliability of the ceramic substrate can be enhanced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional LTCC substrate;

FIG. 2 is a flow chart showing a fabricating method for a ceramic substrate according to an embodiment of the present invention;

FIGS. 3 to 5 are schematic illustrations showing various ceramic substrates according to the fabricating method of FIG. 2;

FIG. 6 is a schematically cross-sectional view showing a ceramic substrate fabricated by the fabricating method of FIG. 2 according to the embodiment of the present invention;

FIG. 7 is a flow chart showing another fabricating method for another ceramic substrate according to the embodiment of the present invention; and

FIG. 8 is schematic illustration showing a ceramic substrate according to the fabricating method of FIG. 7.

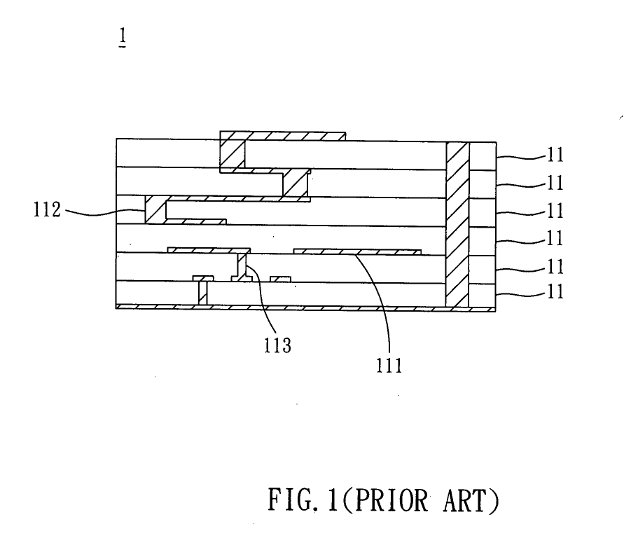

### DETAILED DESCRIPTION OF THE INVENTION

The present invention will be apparent from the following detailed description, which proceeds with reference to the accompanying drawings, wherein the same references relate to the same elements.

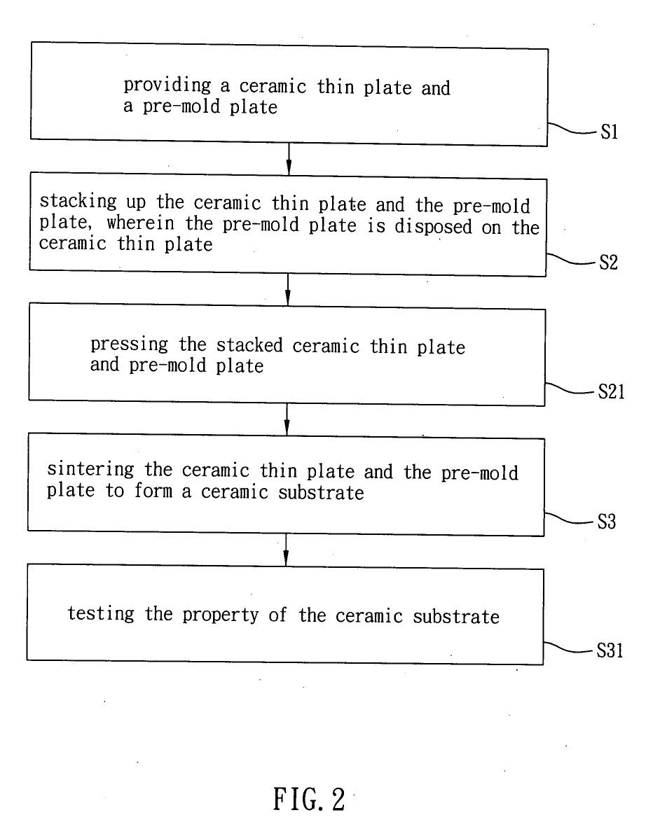

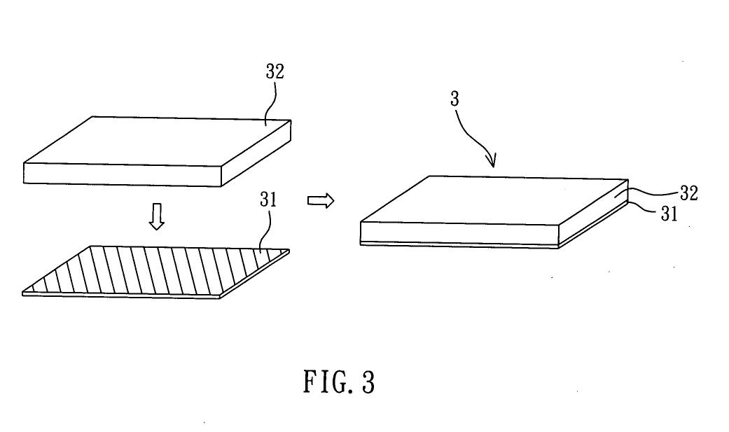

FIG. 2 is a flow chart showing a fabricating method for a ceramic substrate according to an embodiment of the present invention. FIG. 3 is a schematic illustration showing the ceramic substrate according to the fabricating method of FIG. 2. Referring both to FIGS. 2 and 3, the fabricating method for the ceramic substrate according to the embodiment of the present invention includes steps S1, S2, S21, S3 and S31, which will be described in detail in the following.

In step S1, a ceramic thin plate 31 and a pre-mold plate 32 are provided. The pre-mold plate 32 is fabricated according to the following procedures. Firstly, at least one ceramic material is mixed with an inorganic adhesive to obtain a slurry. Then, a polymeric adhesive, a plasticizer or an organic solvent is added to the slurry to prepare another slurry with the suitable viscosity. Next, a scraper is adopted to fabricate the pre-mold plate 32.

The ceramic material may be selected from one of the group consisting of a ceramic powder, a metal oxide powder, a composite metal oxide powder or combinations thereof. The inorganic adhesive has a worse chemical activity than other materials and a sintering temperature lower than that of the ceramic material, and is in a liquid phase during a sintering process. The inorganic adhesive can be the crystallized or non-crystallized glass or glass ceramic. The polymeric adhesive can be polyethylene glycol (PEG), polyvinyl butyal (PVB) or polyvinyl alcohol (PVA). The plasticizer can be dibotylphthalate (DBP). The organic solvent can be 1-Propanol extra pure, toluene or alcohol.

The ceramic thin plate 31 is fabricated according to the following procedures. A lower sintering temperature pre-mold plate (called as first pre-mold plate below) is disposed between two higher sintering temperature pre-mold plates (called as second pre-mold plate below). That is, the first pre-mold plate is sandwiched between the second pre-mold plates. Then, the first pre-mold plate and the second pre-mold plates are processed by a sintering process with a lower sintering temperature so that the first pre-mold plate with the lower sintering temperature is sintered into the ceramic thin plate 31. However, the second pre-mold plates having the higher sintering temperature are not sintered.

The details will be described in the following. Firstly, the ceramic material having the lower sintering temperature and the inorganic adhesive are mixed together to form a second slurry, and the ceramic material having the higher sintering temperature and the inorganic adhesive are mixed together to form a first slurry. Next, the pre-mold plates with the lower sintering temperature and the higher sintering temperature are formed using the first slurry and the second slurry, respectively. Then, the pre-mold plates are stacked up in sequence. Herein, the one first pre-mold plate is sandwiched between the two second pre-mold plates. Next, the stacked pre-mold plates are sintered at the lower sintering temperature so that the first pre-mold plates with the lower sintering temperature are sintered into the ceramic thin plate while the second pre-mold plate having the higher sintering temperature is not sintered yet.

During the sintering process, the second pre-mold plates having the higher sintering temperature provide a constraining force against the first pre-mold plate having the lower sintering temperature, and finally the second pre-mold plates, which have the higher sintering temperature and are not sintered, are removed so that the ceramic thin plate 31, which is thin and flat and has no curved portion, is fabricated.

In addition, the pre-mold plate 32 or the ceramic thin plate 31 in this embodiment can be punched with holes and filled with a conductive material in advance, and the pre-mold plate 32 or the ceramic thin plate 31 is printed with conductive traces before the step of stacking up.

So far, the ceramic thin plate 31 and the pre-mold plate 32 are stacked up. The pre-mold plate 32 is disposed on the ceramic thin plate 31. In more details, the pre-mold plate 32 is attached to the surface of the ceramic thin plate 31. That is, the pre-mold plate 32 is disposed on the ceramic thin plate 31, which is sintered to provide a constraining force to the pre-mold plate 32 that is not sintered. Thus, the phenomenon of contraction occurred during the subsequent sintering process can be reduced.

In addition, the ceramic thin plate 31 is adhered to the pre-mold plate 32 by an adhesive, which is formed on the surface of the pre-mold plate 32 or the ceramic thin plate 31 by way of coating, for example. Then, the ceramic thin plate 31 is aligned with and then adhered to the pre-mold plate 32. The adhesive is an inorganic adhesive, such as crystallized or non-crystallized glass or a glass ceramic. Or, the inorganic adhesive has properties of a worse chemical activity than other materials, a sintering temperature lower than that of the ceramic material, and being in a liquid phase during a sintering process

The method further includes a step 21 after the step S2. In step 21, the stacked ceramic thin plate 31 and pre-mold plate 32 are pressed by way of hot pressing and isostatic pressing so as to make the stack of the ceramic thin plate and the pre-mold plate become denser and to prevent the ceramic substrate 3 from being curved during the subsequent sintering process.

In step S3, the ceramic thin plate 31 and the pre-mold plate 32 are sintered to jointly form the ceramic substrate 3. In step S3, the ceramic thin plate 31 and the pre-mold plate 32 are jointly sintered at the sintering temperature of the pre-mold plate 32 to jointly form the ceramic substrate 3. In the sintering process, the constraining force of the ceramic thin plate 31 against the pre-mold plate 32 is utilized to fabricate the ceramic substrate 3, which is flat and has no sintering contraction and no curved portion.

The method further includes a step S31 of testing the property of the ceramic substrate 3 after step S3. For example, an instrument is utilized to test the dielectric property and the quality property of the sintered ceramic substrate 3, which include a dielectric constant (ε) and a quality factor (Q), so that the ceramic substrate 3 satisfying the specification can be obtained.

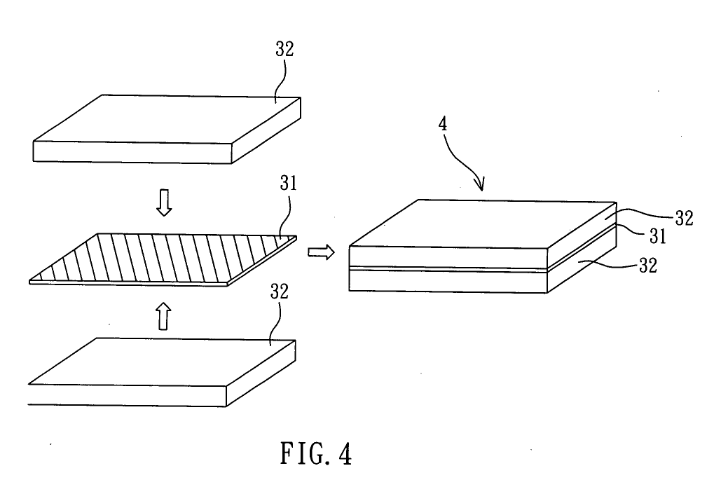

The ceramic substrate 3 of FIG. 3 includes one ceramic thin plate 31 and one pre-mold plate 32. However, the present invention is not particularly limited thereto. For example, as shown in FIG. 4, a ceramic substrate 4 is composed of one ceramic thin plate 31 and two pre-mold plates 32, which are stacked up, and the ceramic thin plate is disposed between the two pre-mold plates 32. The sintered ceramic thin plate 31 provides a constraining force against the two pre-mold plates 32 so as to prevent the two pre-mold plates 32 from contraction during the subsequent sintering process.

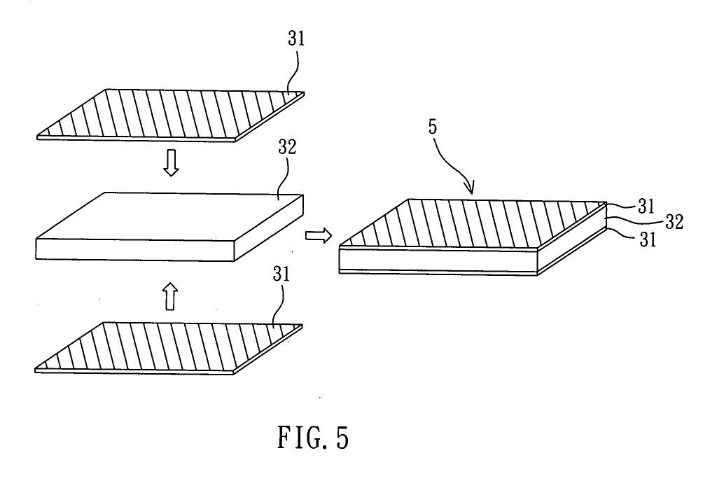

Alternatively, as shown in FIG. 5, a ceramic substrate 5 is composed of one pre-mold plate 32 and two ceramic thin plates 31, which are stacked up, and the pre-mold plate 32 is disposed and sandwiched between the two ceramic thin plates 31. That is, the two ceramic thin plates 31 are respectively adhered to two opposite surfaces of the pre-mold plate 32, and the two ceramic thin plates 31 provide a constraining force against the pre-mold plate 32 to prevent the contraction of the pre-mold plate 32 during the subsequent sintering process.

As mentioned hereinabove, the number of the ceramic thin plate(s) 31 and the number of the pre-mold plate(s) 32 in FIG. 3, 4 or 5 are illustrated as an example. In fact, the ceramic thin plates 31 and the pre-mold plates 32 may be alternately stacked up according to the actual requirements so that the ceramic substrates with the required thickness can be fabricated in a mass production manner.

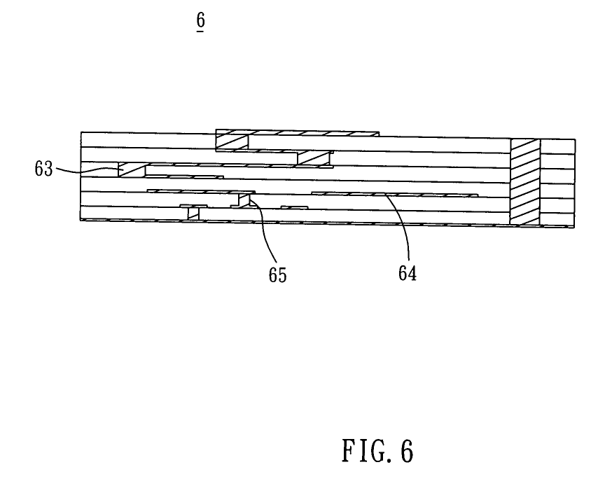

FIG. 6 is a schematically cross-sectional view showing a ceramic substrate 6 fabricated by the fabricating method of FIG. 2 according to the embodiment of the present invention. As shown in FIG. 6, at least one electrical element 63 or at least one conductive layer 64 is disposed on a surface of the ceramic substrate 6 or disposed within the ceramic substrate 6. The electrical element 63 includes, for example but not limited to, a capacitor, a resistor or an inductor. When several conductive layers 64 are provided, the conductive layers 64 can be electrically connected to each other or one another via a plurality of through holes 65. The ceramic substrate 6 of this embodiment is, for example, a LTCC substrate, and is applied to a high precision IC carrier, a multi-chip module and a weather-resistant circuit board.

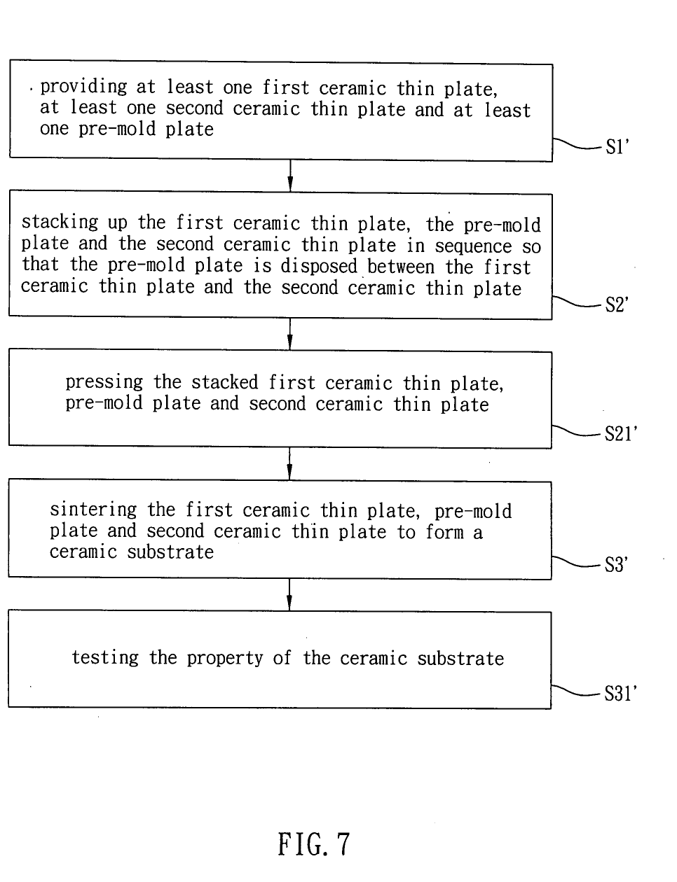

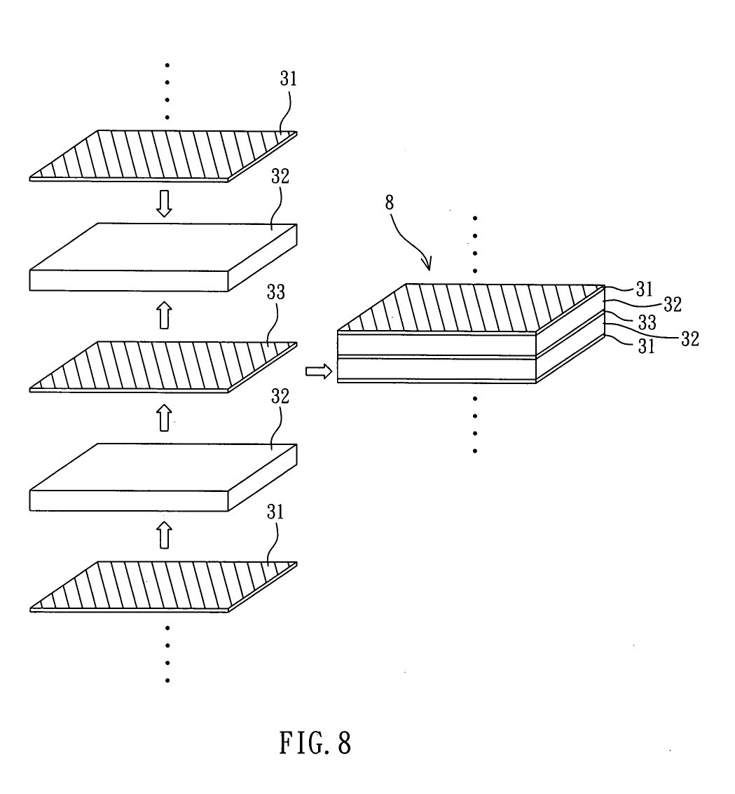

FIG. 7 is a flow chart showing another fabricating method for another ceramic substrate according to the embodiment of the present invention. FIG. 8 is schematic illustration showing a ceramic substrate according to the fabricating method of FIG. 7. Referring to FIGS. 7 and 8, the fabricating method includes steps S1′, S2′, S21′, S3′, S31′ and S3′. In step S1′, at least one first ceramic thin plate 31, at least one second ceramic thin plate 33 and at least one pre-mold plate 32 are provided.

In step S2′, the first ceramic thin plate, the pre-mold plate and the second ceramic thin plate are stacked up in sequence, and the pre-mold plate is disposed between the first ceramic thin plate and the second ceramic thin plate. As shown in FIG. 8, the first ceramic thin plate 31, the pre-mold plate 32, the second ceramic thin plate 33, the pre-mold plate 32 and the first ceramic thin plate 31 are stacked up in sequence. The method further includes step S21′ after the step S2′. In step S21′, the stack first ceramic thin plate 31, pre-mold plate 32 and second ceramic thin plate 33 are pressed by way of hot pressing and isostatic pressing so as to make the stack of the first ceramic thin plate 31, pre-mold plate 32 and second ceramic thin plate 33 denser and to prevent the ceramic substrate 8 from being curved during the subsequent sintering process.

In step S3′, the stacked first ceramic thin plate 31, pre-mold plate 32 and second ceramic thin plate 33 are sintered to form a ceramic substrate 8. The method of this embodiment may further include the step S31′ of testing the property of the ceramic substrate after the step S3′. The detailed implementation and the material of fabrication are similar to those of the fabrication method of FIG. 2 and have been described in the above-mentioned embodiment, so detailed descriptions thereof will be omitted. It is to be noted that the first ceramic thin plate 31 and the second ceramic thin plate 33 constraining the pre-mold plate 32 may be made of different materials as long as the effect of suppressing the contraction of the disposed pre-mold plate during the sintering process can be achieved. In addition, the material of the pre-mold plate 32 can be different from that of each of the first ceramic thin plate 31 and the second ceramic thin plate 33.

In summary, the fabricating method for the ceramic substrate according to the present invention is to dispose a ceramic thin plate on a pre-mold plate so that the ceramic thin plate can provide a constraining force against the pre-mold plate and suppress the contraction of the pre-mold plate during the sintering process. The number of the ceramic thin plates may be greater than one, and those ceramic thin plates may be made of the same material or different materials. Compared with the prior art, the ceramic thin plate and the pre-mold plate have substantially the same property, so the present invention can suppress the contraction during the sintering process and also can prevent the ceramic substrate from being curved so that the flat ceramic substrate can be obtained. Also, the ceramic thin plate for providing a constraining force behaves as one part of the ceramic substrate, so that the removing step can be omitted and the worry of the remained impurity can be avoided. As the result, the yield and the reliability of the ceramic substrate can be enhanced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A fabricating method for a ceramic substrate, the method comprising steps of:
providing a ceramic thin plate and a pre-mold plate;
stacking up the ceramic thin plate and the pre-mold plate; and
sintering the ceramic thin plate and the pre-mold plate, both of which jointly form the ceramic substrate.

2. The method according to claim 1, wherein after the step of stacking up the ceramic thin plate and the pre-mold plate, the method further comprises a step of:
pressing the ceramic thin plate and the pre-mold plate.

3. The method according to claim 2, wherein the ceramic thin plate and the pre-mold plate are pressed by way of hot pressing and isostatic pressing so that a stack of the ceramic thin plate and the pre-mold plate becomes denser.

4. The method according to claim 1, wherein after the step of sintering the ceramic thin plate and the pre-mold plate, the method further comprises a step of:
testing a property of the ceramic substrate.

5. The method according to claim 1, wherein the ceramic thin plate is fabricated by sandwiching a pre-mold plate with a lower sintering temperature between two pre-mold plates with a higher sintering temperature and processing a sintering process with a lower sintering temperature so as to make the pre-mold plate with the lower sintering temperature to form the ceramic thin plate.

6. The method according to claim 1, wherein the pre-mold plate is formed by mixing a ceramic material and an inorganic adhesive.

7. The method according to claim 6, wherein the ceramic material is selected from the group consisting of a ceramic powder, a metal oxide powder, a composite metal oxide powder and combinations thereof.

8. The method according to claim 6, wherein the inorganic adhesive is crystallized or non-crystallized glass or a glass ceramic, or the inorganic adhesive has properties of a worse chemical activity than other materials, a sintering temperature lower than that of the ceramic material, and being in a liquid phase during a sintering process.

9. The method according to claim 6, wherein the pre-mold plate further comprises a polymeric adhesive, a plasticizer or an organic solvent.

10. The method according to claim 9, wherein the polymeric adhesive is polyethylene glycol (PEG), polyvinyl butyal polyvinyl butyal (PVB) or polyvinyl alcohol (PVA), the plasticizer is dibotylphthalate (DBP), and the organic solvent is 1-Propanol extra pure, toluene or alcohol.

11. The method according to claim 1, wherein at least one electrical element or at least one conductive layer is disposed on a surface of the ceramic substrate or embedded in the ceramic substrate.

12. The method according to claim 11, wherein the electrical element is a capacitor, a resistor or an inductor, and when a plurality of conductive layers is disposed on the surface of the ceramic substrate or within the ceramic substrate, the conductive layers are connected together via at least one through hole.

13. The method according to claim 11, wherein the pre-mold plate or the ceramic thin plate is punched with holes and filled with a conductive material, and the pre-mold plate or the ceramic thin plate is printed with conductive traces before the step of stacking up.

14. The method according to claim 1, wherein the ceramic thin plate is adhered to the pre-mold plate by an inorganic adhesive, and the ceramic substrate is an LTCC substrate.

15. The method according to claim 1, wherein a material of the ceramic thin plate is different from a material of the pre-mold plate.

16. The method according to claim 1, wherein the ceramic substrate is formed by stacking up the ceramic thin plate and two pre-mold plates, and the ceramic thin plate is sandwiched between the pre-mold plates.

17. The method according to claim 1, wherein when there are a plurality of the ceramic thin plates and a plurality of the pre-mold plates, the ceramic thin plates and the pre-mold plates are stacked up alternately.

18. A fabricating method for a ceramic substrate, the method comprising steps of:
providing at least one first ceramic thin plate, at least one second ceramic thin plate and at least one pre-mold plate;
stacking up the first ceramic thin plate, the second ceramic thin plate and the pre-mold plate wherein the pre-mold plate is disposed between the first ceramic thin plate and the second ceramic thin plate; and
sintering the first ceramic thin plate, the pre-mold plate and the second ceramic thin plate, all of which jointly form the ceramic substrate.

19. A ceramic substrate, comprising:
a ceramic thin plate and a pre-mold plate, wherein the ceramic thin plate and the pre-mold plate are stacked up and sintered to jointly form the ceramic substrate.

20. The ceramic substrate according to claim 19, wherein the ceramic substrate is an LTCC substrate, and the pre-mold plate is formed by mixing a ceramic material and an inorganic adhesive including crystallized or non-crystallized glass or a glass ceramic, or the inorganic adhesive has properties of a worse chemical activity than other materials, a sintering temperature lower than that of the ceramic material, and being in a liquid phase during a sintering process.
